(19) United States
(12) Patent Application Publication
(10) Pub. No.: US 2022/0092352 A1
(43) Pub. Date: Mar. 24, 2022

(54) LABEL GENERATION FOR ELEMENT OF BUSINESS PROCESS MODEL

(71) Applicant: International Business Machines Corporation, Armonk, NY (US)

(72) Inventors: Xue Han, Beijing (CN); Ya Bin Dang, Beijing (CN); Lijun Mei, Beijing (CN); Ke Wang, Beijing (CN)

(21) Appl. No.: 17/031,376

(22) Filed: Sep. 24, 2020

(51) Int. Cl. G06K 9/62; G06N 5/04; G06K 9/00; G06F 40/30; G06Q 10/06

(52) U.S. Cl. CPC G06K 9/6257; G06N 5/04; G06Q 10/067; G06F 40/30; G06K 9/6218; G06K 9/00463

(57) ABSTRACT

This disclosure provides an approach to generating a label for an element of a business process model. The approach comprises obtaining at least one portion of a text segment that describes an element of a business process model. The approach further comprises applying a question-answering (QA) machine learning model to the at least one portion of the text segment to obtain a set of answers to a set of predetermined questions and generating a label for the element by combining the set of answers according to a format associated with the set of predetermined questions.

### BACKGROUND

The present disclosure relates to business process models, and more specifically, to label generation for an element of a business process model.

In practice, business processes can be described in various representations for different users. For example, textual process descriptions, such as memos, manuals and requirement descriptions, are well-suited for non-technical users, while business process modeling using languages such as Event-driven Process Chain (EPC) and Business Process Modeling and Notation (BPMN) are usually used for technical users. Business process models are representations or illustrations of an organization's business processes, which are critical for effective business process management. For example, modeling business processes can help to better understand the processes and to identify and prevent problems. In large-scale organizations, different representations of business process are usually kept in parallel to make the processes understandable by all users. However, due to the evolving nature of business process management, it is often necessary to transform between different representations.

Multiple challenges arise during transformation between different representations. For example, a textual process description is usually not limited to a predetermined format, that is, it may include one or more paragraphs each including one or more sentences. By contrast, a business process model typically may include a sequence of elements, such as an activity or an event, and each of the elements may be tagged with a label, which is a short natural language text describing the element. Thus, when generating a business process model automatically out of a textual process description, it is necessary to generate a label for an element of the business process model based on the corresponding text segment in the textual process description.

### SUMMARY

Disclosed herein are embodiments of a method, system and computer program product for generating a label for an element of a business process model.

According to an embodiment of the present invention, a computer-implemented method is provided. The method comprises obtaining at least one portion of a text segment that describes an element of a business process model. The method further comprises applying a question-answering (QA) machine learning model to the at least one portion of the text segment to obtain a set of answers to a set of predetermined questions. The method further comprises generating a label for the element by combining the set of answers according to a format associated with the set of predetermined questions.

According to another embodiment of the present invention, a computing system is provided. The computing system comprises a processor and a computer-readable memory unit coupled to the processor. The memory unit comprising instructions that, when executed by the processor, perform actions of obtaining at least one portion of a text segment that describes an element of a business process model. The memory unit further comprising instructions that, when executed by the processor, perform actions of applying a question-answering (QA) machine learning model to the at least one portion of the text segment to obtain a set of answers to a set of predetermined questions. The memory unit further comprising instructions that, when executed by the processor, perform actions of generating a label for the element by combining the set of answers according to a format associated with the set of predetermined questions.

According to further embodiment of the present invention, a computer program product is provided. The computer program product comprises a computer readable storage medium having program instructions embodied therewith. The program instructions are executable by a computer to cause the computer to perform actions of obtaining at least one portion of a text segment that describes an element of a business process model. The program instructions are executable by a computer to further cause the computer to perform actions of applying a question-answering (QA) machine learning model to the at least one portion of the text segment to obtain a set of answers to a set of predetermined questions. The program instructions are executable by a computer to further cause the computer to perform actions of generating a label for the element by combining the set of answers according to a format associated with the set of predetermined questions.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an exemplary business process model with labels according to an embodiment of the present invention.

FIG. 5 is a flow chart showing an exemplary method for generating a label for an element of a business process model according to an embodiment of the present invention.

FIG. 6 shows an exemplary label generation system according to an embodiment of the present invention.

FIG. 7 shows an exemplary hierarchy structure of a text segment that describes an element of a business process model according to an embodiment of the present invention.

FIG. 8 shows an exemplary question-answering (QA) machine learning model according to an embodiment of the present invention.

FIG. 9 shows a table illustrating exemplary labeling styles according to an embodiment of the present invention.

FIG. 10 is an exemplary diagram showing exemplary candidate labels grouped into clusters according to an embodiment of the present invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

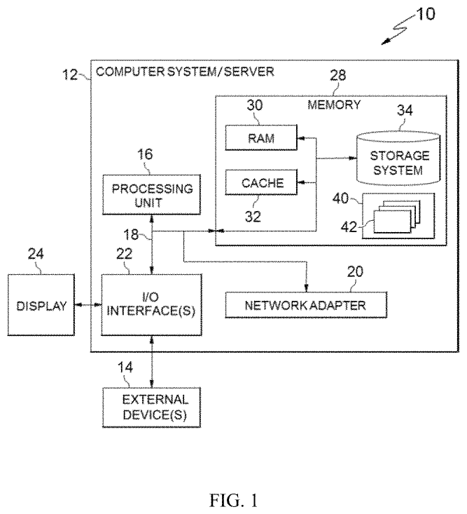

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

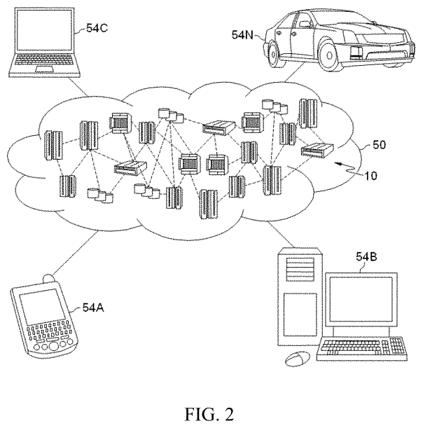

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that cloud computing nodes 10 and cloud computing environment 50 can communicate with any type of computerized device over any type of network and/or network addressable connection (e.g., using a web browser).

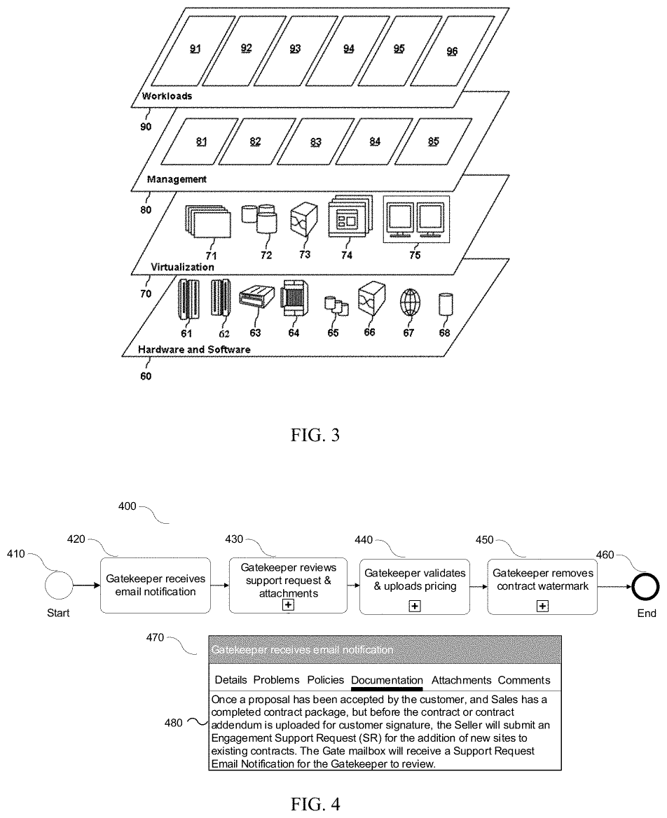

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and label generating 96.

As mentioned above, when generating a business process model automatically out of a textual process description, it is necessary to generate a label for an element of the business process model based on the corresponding text segment in the textual process description. However, when the business process model is displayed in a graphical representation (such as a flow diagram), the maximum length of a label for an element of the business process model displayed in the graphical representation is often limited (e.g., to 20 words), which makes it challenging to describe an element accurately. Moreover, the label for an element of the business process model should retain the key information (e.g., the target system and/or the action) contained in the corresponding text segment and not introduce irrelevant or wrong information.

With reference now to FIG. 4, FIG. 4 shows an exemplary business process model 400 with labels according to an embodiment of the present invention. The business process model 400 is shown in BPMN. However, it should be noted that other business process modeling languages may also be used. It should also be noted that the business process model 400 illustrates a simplified business process by way of example, and the actual business process and the corresponding model can be more complex.

As shown, the business process model 400 includes elements 410-460. Elements 410 and 460 are events that represent things that happen instantaneously, while elements 420-450 are activities that represent units of work that have a duration. It should be noted that the business process model 400 may include any other kinds of elements, such as gateways (not shown). The start event element 410 is shown as a circle with a thin border and the end event element 460 is shown as a circle with a thick border. The elements 420-450 are represented by rounded rectangles, each with a label on it. The label for element 420 is “Gatekeeper receives email notification”, the label for element 430 is “Gatekeeper reviews support request & attachments”, the label for element 440 is “Gatekeeper validates & uploads pricing” and the label for element 450 is “Gatekeeper removes contract watermark”. Note that elements 410 and 460 may also be given labels (not shown) to show, e.g., when should a new instance of the process be started and what conditions hold when an instance of the process completes, respectively. As discussed above, there may be a maximum length limitation for the labels, which may be, for example, 516-20 words.

Elements 420-450 may be expanded to show more information regarding the elements. For example, after clicking on the element 420, a block 470 will be displayed. The block 470 may show the label “Gatekeeper receives email notification” on the top, as well as multiple tabs showing other information regarding the activity of the element 420, such as details, problems, policies, documentation, attachments and comments. The “Documentation” tab may contain a text segment 480 that describes the element 420. According to an embodiment of the invention, the text segment 480 is taken from a textual process description (such as a memo, a manual, a log, etc.). According to an embodiment of the invention, the business process model 400 was generated automatically out of the textual process description and the label for the element 420 was generated based on the text segment 480.

The text segment 480 is as follows:

Once a proposal has been accepted by the customer, and Sales has a completed contract package, but before the contract or contract addendum is uploaded for customer signature, the Seller will submit an Engagement Support Request (SR) for the addition of new sites to existing contracts. The Gate mailbox will receive a Support Request Email Notification for the Gatekeeper to review.

Although the text segment 480 gives a more detailed description of the element 420, but it is too long and may contain noisy information that is insignificant and irrelevant with the key information of the activity. Conventional Natural Language Processing tools such as generative deep learning models and extractive deep learning models are generally not applicable in generating a label for the element 420 based on the text segment 480. For example, by applying a trained generative deep learning model called “gigaword_nocopy_acc_51.33_ppl_12.74_e20.pt” in the Opennmt-py script to the text segment 480, a label generated for the element 420 is “SR will submit SR for”, which is not grammatically correct and does not capture the key information of the activity. As another example, the label generated by extractive deep learning models (such as, Opennmt-giga, Opennmt-transformer and Textrank) may be a complete sentence in the text segment 480, which may exceed the maximum length limitation, or the extractive deep learning models may even fail to generate a label.

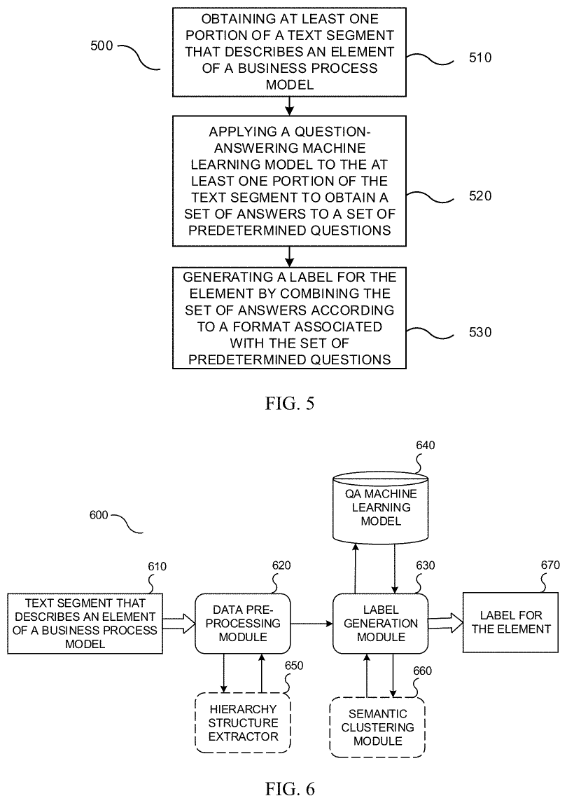

Now, with reference to FIGS. 5-10, some embodiments of the present invention will be described below.

With reference now to FIG. 5, FIG. 5 is a flow chart showing an exemplary method 500 for generating a label for an element of a business process model according to an embodiment of the present invention.

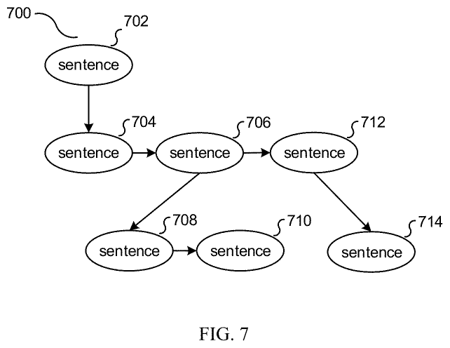

As shown at 510, the method 500 may include obtaining at least one portion of a text segment that describes an element of a business process model. For example, the text segment may contain one or more semantic components (such as one or more sentences, or one or more paragraphs) in a textual process description. According to an embodiment of the invention, obtaining the at least one portion of the text segment may comprise at least one of: removing one or more sentences in the text segment that are at one or more lower levels of a hierarchy structure of the text segment; and removing one or more sentences in the text segment that contain predefined keywords (such as “tool” and “note”). The hierarchy structure may be extracted based on layout information and/or semantic information of the text segment. The one or more sentences that are at one or more lower levels of the hierarchy structure of the text segment and/or the one or more sentences that contain predefined keywords may contain noisy information. Therefore, by removing the one or more sentences from the text segment, useful and important information will remain, which may facilitate the generation of a more accurate label. The pre-processing of the text segment will be described below with respect to FIG. 6 and FIG. 7 in more detail. According to an embodiment of the invention, all of the text segment that describes the element of the business process model may be obtained without removing any portion of the text segment.

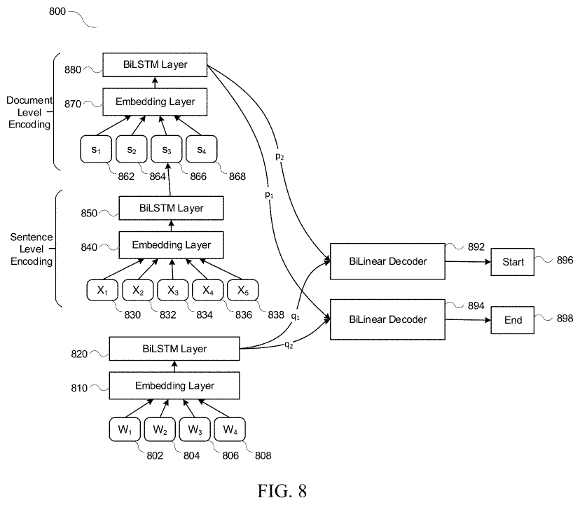

As shown at 520, a question-answering (QA) machine learning model may be applied to the at least one portion of the text segment to obtain a set of answers to a set of predetermined questions. Note that any appropriate QA machine learning model that takes a passage of text and a corresponding question as inputs and gives an answer as output may be used here. According to an embodiment of the invention, the QA machine learning model may have been trained using a training dataset comprising pairs of inputs and corresponding outputs. Each of the output may be a portion of a label of an element of a business process model, and each of the input may be extracted from a text segment that describes the element by at least one of: removing one or more sentences in the text segment that are at one or more lower levels of a hierarchy structure of the text segment; and removing one or more sentences in the text segment that contain predefined keywords. Thereby, when building a training dataset, the input may also be pre-processed to remove noisy information, which may improve the performance of the machine learning model. The structure of the machine learning model will be described below with respect to FIGS. 6 and 8 in more detail.

According to an embodiment of the invention, each of the set of answers may be a span of texts selected from the at least one portion of the text segment. According to an embodiment of the invention, the QA machine learning model may be applied to the at least one portion of the text segment to obtain a first answer to a first question of the set of predetermined questions, and then the QA machine learning model may be applied to the at least one portion of the text segment to obtain a second answer to a second question of the set of predetermined questions, wherein a component of the second question is based on the first answer. According to another embodiment of the invention, the application of the QA machine learning model to the at least one portion of the text segment may be performed in parallel for at least some of the set of questions. By leveraging a QA machine learning model, the method 500 may extract key information of the text segment (such as the subject, the action, and the like).

According to an embodiment of the invention, at least one answer may be obtained for each of the set of predetermined questions, and each of the at least one answer may have a score that indicates a probability that the obtained answer is ground truth.

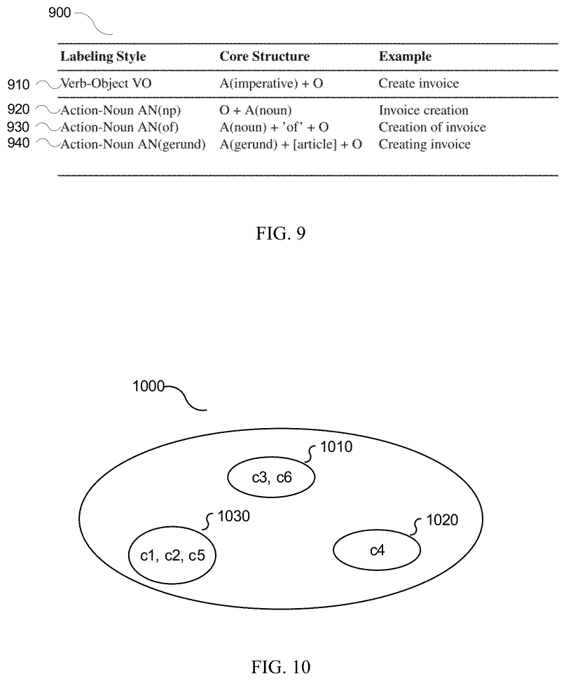

As shown at 530, a label for the element may be generated by combining the set of answers according to a format associated with the set of predetermined questions. According to an embodiment of the invention, the format may be designed such that the combined set of answers conforms to a predetermined labeling style. Thereby, the method 500 may provide greater flexibility in customizing the label. Examples of labeling styles will be described below with respect to FIG. 9 in more detail.

According to an embodiment of the invention, as mentioned above, at least one answer may be obtained for each of the set of predetermined questions, and each of the at least one answer may have a score that indicates a probability that the obtained answer is ground truth. The label for the element may be generated based at least on the scores of the answers. According to an embodiment of the invention, answers to respective ones of the set of predetermined questions may be cascaded according to the format associated with the set of predetermined questions to generate a plurality of candidate labels for the element, and one of the plurality of candidate labels may be selected as the label for the element based at least on the scores of the answers. According to an embodiment of the invention, the plurality of candidate labels may be grouped into one or more clusters by semantic clustering, and the label for the element may be selected from one of the one or more clusters that has the largest number of candidate labels. Semantic clustering of the candidate labels will be described below with respect to FIG. 10 in more detail. According to an embodiment of the invention, generating the label for the element may further comprise discarding a candidate label that exceeds a predetermined length limit.

It should be noted that the processing of the method 500 according to embodiments of this disclosure could be implemented by computer system/server 12 of FIG. 1. More details about the method 500 will be illustrated in connection with FIGS. 6-10.

FIG. 6 shows an exemplary label generation system 600 according to an embodiment of the present invention. In FIG. 6, the rounded rectangles denote processing logics, and the rectangles denote data or artifacts of the processing. It would be appreciated that, any one of the processing logics may be implemented by software (such as software running on a general-purpose computer or a dedicated computer), hardware (circuitry, dedicated chip, etc.), or a combination of both. For example, the processing logics in FIG. 6 may be implemented as software running on the computer system/server 12 of FIG. 1.

With reference to FIG. 6, the exemplary system 600 may comprise a data pre-processing module 620 and a label generation module 630. The exemplary system 600 may also comprise a hierarchy structure extractor 650 and/or a semantic clustering module 660. The hierarchy structure extractor 650 and the semantic clustering module 660 are represented by dashed lines, which indicate that they are optional. According to an embodiment of the invention, the hierarchy structure extractor 650 and the semantic clustering module 660 may be external to the system 600, or at least one of the hierarchy structure extractor 650 and the semantic clustering module 660 may be included in a module of the system 600. For example, the hierarchy structure extractor 650 may be included in the data pre-processing module 620, and/or the semantic clustering module 660 may be a sub-module in the semantic clustering module 660.

A text segment 610 (such as the text segment 480) that describes an element (such as the element 420 in FIG. 4) of a business process model may be input into the data pre-processing module 620. The text segment 610 may be taken from a textual process description (such as a memo, a manual, a log, etc.), and may contain one or more semantic components (such as one or more sentences, or one or more paragraphs) in the textual process description. Here, a sentence is not limited to a complete sentence and may be a phrase, for example, “login a website” or “email received”.

The data pre-processing module 620 may obtain at least one portion of the text segment 610. According to an embodiment of the invention, the data pre-processing module 620 may send the text segment 610 to the hierarchy structure extractor 650, and the hierarchy structure extractor 650 may extract a hierarchy structure of the text segment based on layout information and/or semantic information of the text segment. The layout information may include but is not limited to at least one of font type, font size, text color, text indent, associated number, etc. The semantic information may be analyzed using existing tools, such as unsupervised methods to recognizing discourse relations, or discourse segmentation methods (such as TextTiling). By referring to FIG. 7, exemplary operations of the hierarchy structure extractor 650 will be described below in more detail.

FIG. 7 shows an exemplary hierarchy structure 700 of a text segment that describes an element of a business process model according to an embodiment of the present invention. The text segment may include seven sentences, 702-714. An example of the text segment, referred to as T1 hereinafter, may be as follows:

1. Launch a Session.//Sentence 702

1.1 Log in system A.//Sentence 704

1.2 Log in http://www.website1.com/ with ID and password. //Sentence 706

(Please ensure that the SOCKS client is enabled). //Sentence 708

Note: To register a new user ID, please click http://www.website2.com/. //Sentence 710

1.3 After connecting to the server, please install SOCKS Client to launch the session.

//Sentence 712

Link: (http://www.website3.com/). //Sentence 714

It should be noted that the text shown above after “//” in each line is an identifier of the sentence in that line, rather than a part of the sentence itself. The corresponding hierarchy structure 700 may comprise three levels, wherein sentence 702 is at the first/top level, sentences 704, 706 and 712 are at the second/middle level and sentences 708, 710 and 714 are at the third/lowest level. Note that, if Sentence A is at a level higher than Sentence B, it is more likely that Sentence A relates to the key information of the text segment. The hierarchy structure 700 may be generated by the hierarchy structure extractor 650 based on layout information and/or semantic information of the text segment.

According to an embodiment of the invention, the hierarchy structure extractor 650 may analyze the layout information of the text segment T1. According to an embodiment of the invention, the hierarchy structure extractor 650 may identify that sentence 702 is started with a number “1” and sentences 704, 706 and 712 are started with “1.1”, “1.2” and “1.3”, respectively. In addition, sentences 708, 710 and 714 are indented by three spaces. Based on the associated numbers and the text indent, the hierarchy structure extractor 650 may determine that sentences 708, 710 and 714 are at a lower level than sentences 704, 706 and 712 and sentence 702 is at a higher level than sentences 704, 706 and 712, and thereby derive the hierarchy structure 700. According to an embodiment of the invention, the text segment may include other layout information in addition to or instead of the associated numbers and the text indent. For example, sentence 702 may be represented in 12-point, Arial, boldface type, sentences 704, 706 and 712 may be represented in 11-point, Times New Roman font, and sentences 708, 710 and 714 may be represented in 10-point, Times New Roman, italic type. In such cases, the hierarchy structure extractor 650 may extract the hierarchy structure 700 based at least on the font information.

According to an embodiment of the invention, the hierarchy structure extractor 650 may analyze the semantic information of the above text segment T1 using existing tools, such as unsupervised methods to recognizing discourse relations and discourse segmentation methods (such as TextTiling), to extract the hierarchy structure 700. Semantic analysis may be useful particularly when the layout information is insufficient, for example, when the text segment is taken from a file that contains plain text (e.g., a txt document). It should be noted that the hierarchy structure extractor 650 may extract the hierarchy structure 700 in any other appropriate way, e.g., based on a combination of the layout information and semantic information, or based on a hierarchy description, etc.

Now referring back to FIG. 6, the hierarchy structure extractor 650 may provide the extracted hierarchy structure 700 in FIG. 7 to the data pre-processing module 620. The data pre-processing module 620 may remove one or more sentences in the text segment that are at one or more lower levels of a hierarchy structure of the text segment. For example, the data pre-processing module 620 may remove sentences 708, 710 and 714 that are at the lowest level of the hierarchy structure 700. It should be noted that the hierarchy structure may include more than three levels, and the data pre-processing module 620 may also remove at least the sentences that are at the second lowest level of the hierarchy structure. The number of lower levels that are removed may be determined based on the hierarchy structure itself and/or any other criteria (e.g., the sentences that are removed should be less than half of the sentences).

According to an embodiment of the invention, the data pre-processing module 620 may remove one or more sentences in the text segment that contain predefined keywords. The predefined keywords may include “note”, “link”, “tool”, and the like. The sentences including such predefined keywords may represent a notice or auxiliary information that is less important and thus can be removed. Taking the text segment T1 as an example, the data pre-processing module 620 may identify that sentence 710 contains the keyword “note” and sentence 714 contains the keyword “link”, and thus remove sentences 710 and 714.

After the data pre-processing module 620 obtains at least one portion of a text segment that describes an element of a business process model, it may provide the at least one portion of the text segment to the label generation module 630. The label generation module 630 may apply a question-answering (QA) machine learning model 640 to the at least one portion of the text segment to obtain a set of answers to a set of predetermined questions. According to an embodiment of the invention, each of the set of answers may be a span of texts selected from the at least one portion of the text segment. The QA machine learning model 640 may be any appropriate machine learning model that takes a passage of text and a corresponding question as inputs and gives an answer (or more than one answer) as output, such as Match-LSTM (Long Short-Term Memory), Attentive Reader, and the like. By referring to FIG. 8, an exemplary structure of a QA machine learning model will be described below in more detail.

FIG. 8 shows an exemplary QA machine learning model 800 according to an embodiment of the present invention. It should be noted that FIG. 8 is a schematic diagram, and the actual QA machine learning model 800 may contain a great number of layers and units, which are omitted here. It should also be noted that the QA machine learning model 800 is a span prediction model (also referred to as an extractive QA model), which means that the answer obtained by the QA machine learning model 800 is a span of texts selected from the at least one portion of the text segment that is input to it. As shown in FIG. 8 and described below, a question is input into the QA machine learning model 800. In addition, the at least one portion of the text segment (referred to as the pre-processed text segment hereinafter) obtained by the data pre-processing module 620 is also input into the QA machine learning model 800. Finally, the QA machine learning model 800 obtains a start position 896 and an end position 898 of the pre-processed text segment to form an answer to the question.

The question may include four question words W₁-W₄ 802-808. For example, the question may be “What is the system”. Each of the question words 802-808 goes through an embedding layer 810 that maps each question word into its word embedding and a BiLSTM (Bidirectional LSTM) layer 820 that extracts context feature of the question to obtain a vector representation of the question, which is denoted by q=(q₁, q₂, q₃, q₄).

The pre-processed text segment may include four sentences S₁-S₄ 862-868, and each sentence may include one or more words. For example, the sentence S₃ 866 may include five words X₁-X₄ 830-838, such as “register a new user id”. In the sentence level encoding stage, each sentence is processed in a similar way as the question. Specifically, each of the words 830-838 goes through an embedding layer 840 that maps the word into its word embedding and a BiLSTM layer 850 that extracts context feature of the sentence S₃ 866 to obtain a vector representation of the sentence S₃ 866. The sentences S₁ 862, S₂ 864 and S₄ 868 may be processed similarly to obtain vector representations thereof. Then, in the document level encoding stage, each of the vector representations of sentences S₁-S₄ 862-868 goes through an embedding layer 870 and a BiLSTM layer 880 to obtain a vector representation of the pre-processed text segment p=(p₁, p₂, . . . , p₁), where 1 is the total number of words in the pre-processed text segment. Then, the vector representation of the question q and the vector representation of the pre-processed text segment p (only p₁, p₂, q₁, and q₂ are illustrated for simplicity) are processed by a bilinear decoder 892 and a bilinear decoder 894 to obtain a start position 896 and an end position 898 in the pre-processed text segment, respectively. For example, the bilinear decoder 892 and the bilinear decoder 894 may be bilinear classifiers. By extracting a span of texts from the pre-processed text segment based on the start position 896 and the end position 898, an answer to the question may be obtained and provided to the label generation module 630. It will be appreciated that the QA machine learning model 800 may have a structure different from that shown in FIG. 8. For example, the QA machine learning model 800 may include one or more additional layers, e.g., an attention layer.

Now referring back to FIG. 6, the QA machine learning model 640 may be applied multiple times for a set of predetermined questions. The application of the QA machine learning model 640 to the set of questions may be performed in sequential or in parallel. According to an embodiment of the invention, the QA machine learning model 640 may be applied to the pre-processed text segment received from the data pre-processing module 620 to obtain a first answer to a first question of the set of predetermined questions, and then the QA machine learning model 640 may be applied to the pre-processed text segment to obtain a second answer to a second question of the set of predetermined questions, wherein a component of the second question is based on the first answer. More questions can be input into the QA machine learning model 640 to get corresponding answers, which is not limited. According to an embodiment of the invention, the label generation module 630 may generate a label for the element 670 by combining the set of answers obtained from the QA machine learning model 640 according to a format associated with the set of predetermined questions. The set of predetermined questions may be designed to extract key information of the text segment that describes an element of a business process model.

For example, assuming that the pre-processed text segment received from the data pre-processing module 620 is the text segment 480 in FIG. 4. The first question in the set of predetermined questions may be: “What is the system?” The second question in the set of predetermined questions may be: “What do *** do?”, wherein “***” denotes a component of the second question that is based on the answer to the first question. By applying the QA machine learning model 640 to the text segment 480 using the first question, the label generation module 630 may obtain an answer to the first question, which is “Gate”. By replacing the component of the second question “***” with the answer to the first question, the second question may be determined as “What will Gate do?”. By applying the QA machine learning model 640 to the text segment 480 using the second question, the label generation module 630 may obtain an answer to the second question, which is “receive a Support Request Email Notification”. The label generation module 630 may generate a label “Gate receives a Support Request Email Notification” by combining the answers to the first and second questions according to a format associated with the set of predetermined questions. Here, the format may be “answer1+answer2”, wherein answerl refers to the answer to the first question and answer2 refers to the answer to the second question. Another possible format may be “answer2[gerund]+‘by’+answer1”, wherein the answer2 is represented using a present participle as a gerund. According to this format, the label generated by the label generation module 630 may be “Receiving a Support Request Email Notification by Gate”. Note that during combination of the answers, the label generation module 630 may transform the form of any word in the answers to make the label grammatically correct. The label generated by the label generation module 630 is more similar to the ground truth “Gatekeeper receives email notification”, compared to the labels generated by conventional Natural Language Processing tools as mentioned above.

According to an embodiment of the invention, the application of the QA machine learning model 640 to the pre-processed text segment may be performed in parallel for at least some of the set of questions. For example, the first question in the set of predetermined questions may be: “What is the system?” The second question in the set of predetermined questions may be: “What is the operation?” Since the first and second questions do not dependent on each other, obtaining answers to the two questions may be performed in parallel using two instances of the QA machine learning model 640.

According to an embodiment of the invention, the QA machine learning model 640 may have been trained using a training dataset comprising pairs of inputs and corresponding outputs. Each of output is a portion of a label of an element of a business process model, and each of the input is extracted from a text segment that describes the element by at least one of: removing one or more sentences in the text segment that are at one or more lower levels of a hierarchy structure of the text segment; and removing one or more sentences in the text segment that contain predefined keywords. That is to say, the training text segment may be processed in advance by the data pre-processing module 620 to remove noisy information.

Consider using the text segment T1 as described above to build a training dataset. The text segment T1 describes an element of a business process model, and the label for the element may be pre-determined as “Launch a session” (e.g., by a technician) Similar to the process described above with respect to FIG. 7, the data pre-processing module 620 may remove sentences 708, 710 and 714 from the text segment T1 based on a hierarchy structure of the text segment T1. Accordingly, the pre-processed text segment T1 including sentences 702, 704, 706 and 712 may be provided as input for building a training dataset. Alternatively, the data pre-processing module 620 may remove sentences 710 and 714 that contain predefined keywords from the text segment T1. Accordingly, the pre-processed text segment T1 including sentences 702, 704, 706, 708 and 712 may be provided as input for building a training dataset. The first question in the set of predetermined questions may be: “What is the action?”, and the second question in the set of predetermined questions may be: “What is the object of ***?”, wherein “***” denotes a component of the second question that is based on the answer to the first question. The output for the training dataset (i.e., the answer to each question) may be a portion of the label “Launch a Session”. For the first question, the output may be provided as “launch”. For the second question, the output may be provided as “session”. Thereby, a training dataset may be built to train the QA machine learning model 640. In practice, the QA machine learning model 640 may have been trained using a great number of (e.g., tens of thousands of) training datasets to ensure a good performance.

According to an embodiment of the invention, the format associated with the set of predetermined questions is designed such that the combined set of answers conforms to a predetermined labeling style. FIG. 9 shows a table 900 illustrating exemplary labeling styles according to an embodiment of the present invention. In the first class of labeling styles, the action is given as a verb. As shown, in the Verb-Object (VO) labeling style 910, the verb is given as an imperative verb in the beginning of the label, followed by an object. To conform to the labeling style 910, the format for the label may be designed as “answer1(imperative) 30 answer2”. Considering the case where the first answer obtained by the label generation module 630 is “create” and the second answer obtained by the label generation module 630 is “invoice”, the label generated according to the format will be “Create invoice.”

In the second class of labeling styles, the action is captured as a noun. Three different styles 920-940 in FIG. 9 belong to the second class. In the Action-Noun (AN(np)) labeling style 920, the nominalized action is provided at the end of the label. To conform to the labeling style 920, the format for the label may be designed as “answer2 +answerl(noun).” Thus, for the above case, the label generated according to the format will be “Invoice creation”. In the Action-Noun (AN(of)) labeling style 930, a preposition “of” is used to separate the nominalized action from the object. To conform to the labeling style 930, the format for the label may be designed as “answer1(noun)+‘of’ +answer2.” Thus, for the above case, the label generated according to the format will be “Creation of invoice.” In the Action-Noun (AN(gerund)) labeling style 940, different from the labeling style 910, the action is represented using a present participle as a gerund in the beginning of the label. To conform to the labeling style 940, the format for the label may be designed as “answer1(gerund)+[article]+answer2.” Here, a potential article may be added between the two answers to obtain a grammatically correct label. For the above case, the label generated according to the format will be “Creating invoice.” It should be noted that the labeling styles 910-940 are illustrated by way of example, but not by way of limitation. Any other appropriate labeling styles may be utilized.

Referring back to FIG. 6, according to an embodiment of the invention, the label generation module 630 may obtain at least one answer for each of the set of predetermined questions, and each of the at least one answer may have a score that indicates a probability that the obtained answer is ground truth. The score may be calculated by the QA machine learning model 640. The label generation module 630 may generate the label for the element based at least on the scores of the answers. Continuing the example relating to generating a label based on the text segment 480, for the first question “What is the system?,” the label generation module 630 may obtain the following answers from the QA machine learning model 640:

| Rank | Answer | Score |
|---|---|---|
| 1 | Gate | 0.19373165 |
| 2 | Support Request | 0.08052760 |
| 3 | Sales | 0.05425022 |

For each answer to the first question, the second question will be determined by replacing the component “***” with the answer to the first question. For example, for the answer “Gate,” the second question is determined as “What will Gate do?” and the label generation module 630 may obtain the following answers from the QA machine learning model 640:

| Rank | Answer | Score |
|---|---|---|
| 1 | receive a Support Request Email Notification | 0.03707864 |
| 2 | review | 0.01873733 |
| 3 | has a completed contract package | 0.01585925 |

For each of the other answers “Support Request” and “Sales,” the second question may be determined, and at least one answer may be obtained for the second question in a similar way.

According to an embodiment of the invention, the label generation module 630 may cascade answers to respective ones of the set of predetermined questions according to the format associated with the set of predetermined questions to generate a plurality of candidate labels for the element, and one of the plurality of candidate labels may be selected as the label for the element 670 based at least on the scores of the answers. For example, considering the above example where there are two predetermined questions, if three answers are obtained for the first question and four answers are obtained for the second question, a total number of 12 candidate labels may be generated by cascading answers to respective ones of the two questions, and each candidate label may be assigned a score based on the scores of the answers constituting it. The score for a candidate label may be calculated by multiplying the scores of each answer constituting the label, by calculating a weighted sum of the answers constituting the label, etc. Continuing the above example, the label generation module 630 may generate the following three candidate labels among others:

Label 1: “Gate receives a Support Request Email Notification;”

Label 2: “Gate reviews;”

Label 3: “Gate has a completed contract package.”

The score for Label 1 may be calculated as: “0.19373165×0.03707864=0.007183306106956”, the score for Label 2 may be calculated as: “0.19373165×0.01873733=0.0036300138574945”, and the score for Label 3 may be calculated as “0.19373165×0.01585925=0.0030724386702625”. The label generation module 630 may select a label from the candidate labels as the label for the element 670. According to an embodiment of the invention, the label generation module 630 may select the candidate label with the highest score, such as Label 1 in this example. The label generation module 630 may select the label for the element 670 based on one or more other criteria. According to an embodiment of the invention, the label generation module 630 may discard a candidate label that exceeds a predetermined length limit, in order to meet the requirement of a business process modeling language (such as EPC and BPMN). For example, the label generation module 630 may select the candidate label that has the highest score among the candidate labels that do not exceed a predetermined length limit (such as 10 or 20 words).

According to an embodiment of the invention, the label generation module 630 may select the label for the element 670 in combination with the semantic clustering module 660. According to an embodiment of the invention, the label generation module 630 may send the plurality of labels to the semantic clustering module 660, and the semantic clustering module 660 may group the plurality of candidate labels into one or more clusters by semantic clustering. The semantic clustering method may include, for example, K-Means, Chameleon, DBSCAN (Density-Based Spatial Clustering of Applications with Noise), etc.

FIG. 10 is an exemplary diagram 1000 showing exemplary candidate labels grouped into clusters according to an embodiment of the present invention. The candidate labels may be grouped by the semantic clustering module 660, or by the label generation module 630 (e.g., if the label generation module 630 comprises a sub-module that performs semantic clustering).

As shown in FIG. 10, semantic clustering may be performed with respect to six candidate labels, c1-c6, and the candidate labels are grouped into three clusters 1010, 1020 and 1030 based on similarity of their semantic contents. Each cluster may include one or more candidate labels. The cluster 1010 may include candidate labels c3 and c6, the cluster 1020 may include candidate label c4, and the cluster 1030 may include candidate labels c1, c2 and c5. The candidate labels in a same cluster may have similar meanings, while the candidate labels in different clusters may have distinct meanings. According to an embodiment of the invention, some or all of the candidate labels in the cluster that has the least number of candidate labels may be discarded. In FIG. 10, the cluster 1020 has the least number of candidate labels and the candidate label c4 included in the cluster 1020 may be discarded. By discarding the candidate labels in the cluster that has the least number of candidate labels, it may be possible to exclude outliers and a more accurate label may be selected. According to an embodiment of the invention, after the candidate labels in the cluster that has the least number of candidate labels are discarded, the label for the element 670 may be selected from one of the clusters. In the example shown in FIG. 10, the label for the element may be selected from the cluster 1010 or the cluster 1030. For example, the candidate label with the highest score may be selected from c1, c2, c3, c5 and c6. According to an embodiment of the invention, the label for the element may be selected from one of the one or more clusters that has the largest number of candidate labels. For example, the candidate label with the highest score in the cluster that has the largest number of candidate labels may be selected. In the example shown in FIG. 10, the label for the element may be selected from c1, c2 and c5 in the cluster 1030. It should be noted that any other appropriate criteria may be utilized in selecting the label for the element based on the semantic clustering.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining, by one or more processing units, at least one portion of a text segment that describes an element of a business process model;
applying, by one or more processing units, a question-answering (QA) machine learning model to the at least one portion of the text segment to obtain a set of answers to a set of predetermined questions; and
generating, by one or more processing units, a label for the element by combining the set of answers according to a format associated with the set of predetermined questions.

2. The method of claim 1, wherein obtaining the at least one portion of the text segment comprises at least one of:
removing, by one or more processing units, one or more sentences in the text segment that are at one or more lower levels of a hierarchy structure of the text segment; and
removing, by one or more processing units, one or more sentences in the text segment that contain predefined keywords.

3. The method of claim 2, wherein the hierarchy structure is extracted based on layout information and/or semantic information of the text segment.

4. The method of claim 1, wherein each of the set of answers is a span of texts selected from the at least one portion of the text segment.

5. The method of claim 1, wherein applying the QA machine learning model to the at least one portion of the text segment to obtain the set of answers to the set of predetermined questions comprises:
applying, by one or more processing units, the QA machine learning model to the at least one portion of the text segment to obtain a first answer to a first question of the set of predetermined questions; and
applying, by one or more processing units, the QA machine learning model to the at least one portion of the text segment to obtain a second answer to a second question of the set of predetermined questions, wherein a component of the second question is based on the first answer.

6. The method of claim 1, wherein the format is designed such that the combined set of answers conforms to a predetermined labeling style.

7. The method of claim 1, wherein at least one answer is obtained for each of the set of predetermined questions, each of the at least one answer having a score that indicates a probability that the obtained answer is ground truth, and wherein generating, by one or more processing units, the label for the element comprises:
cascading, by one or more processing units, answers to respective ones of the set of predetermined questions according to the format to generate a plurality of candidate labels for the element; and
selecting, by one or more processing units, one of the plurality of candidate labels as the label for the element based at least on the scores of the answers.

8. The method of claim 7, wherein the plurality of candidate labels are grouped into one or more clusters by semantic clustering, and wherein the label for the element is selected from one of the one or more clusters that has the largest number of candidate labels.

9. The method of claim 7, wherein generating the label for the element further comprises:
discarding, by one or more processing units, a candidate label that exceeds a predetermined length limit.

10. The method of claim 1, wherein the QA machine learning model has been trained using a training dataset comprising pairs of inputs and corresponding outputs, wherein each of the output is a portion of a label of an element of a business process model, and each of the input is extracted from a text segment that describes the element by at least one of:
removing, by one or more processing units, one or more sentences in the text segment that are at one or more lower levels of a hierarchy structure of the text segment; and
removing, by one or more processing units, one or more sentences in the text segment that contain predefined keywords.

11. A computing system, comprising:
a processor;
a computer-readable memory unit coupled to the processor, the memory unit comprising instructions that, when executed by the processor, perform actions of:
obtaining at least one portion of a text segment that describes an element of a business process model;
applying a question-answering (QA) machine learning model to the at least one portion of the text segment to obtain a set of answers to a set of predetermined questions; and
generating a label for the element by combining the set of answers according to a format associated with the set of predetermined questions.

12. The computing system of claim 11, wherein obtaining the at least one portion of the text segment comprises at least one of:
removing one or more sentences in the text segment that are at one or more lower levels of a hierarchy structure of the text segment, wherein the hierarchy structure is extracted based on layout information and/or semantic information of the text segment; and
removing one or more sentences in the text segment that contain predefined keywords.

13. The computing system of claim 11, wherein at least one answer is obtained for each of the set of predetermined questions, each of the at least one answer having a score that indicates a probability that the obtained answer is ground truth, and wherein generating the label for the element comprises:
cascading answers to respective ones of the set of predetermined questions according to the format to generate a plurality of candidate labels for the element; and
selecting one of the plurality of candidate labels as the label for the element based at least on the scores of the answers.

14. The computing system of claim 13, wherein the plurality of candidate labels are grouped into one or more clusters by semantic clustering, and wherein the label for the element is selected from one of the one or more clusters that has the largest number of candidate labels.

15. The computing system of claim 13, wherein generating the label for the element further comprises:
discarding a candidate label that exceeds a predetermined length limit.

16. A computer program product, comprising a computer readable storage medium having program instructions embodied therewith, the program instructions executable by a processor to cause the processor to perform actions of:
obtaining at least one portion of a text segment that describes an element of a business process model;
applying a question-answering (QA) machine learning model to the at least one portion of the text segment to obtain a set of answers to a set of predetermined questions; and
generating a label for the element by combining the set of answers according to a format associated with the set of predetermined questions.

17. The computer program product of claim 16, wherein obtaining the at least one portion of the text segment comprises at least one of:
removing one or more sentences in the text segment that are at one or more lower levels of a hierarchy structure of the text segment, wherein the hierarchy structure is extracted based on layout information and/or semantic information of the text segment; and
removing one or more sentences in the text segment that contain predefined keywords.

18. The computer program product of claim 16, wherein each of the set of answers is a span of texts selected from the at least one portion of the text segment.

19. The computer program product of claim 16, wherein applying the QA machine learning model to the at least one portion of the text segment to obtain the set of answers to the set of predetermined questions comprises:
applying the QA machine learning model to the at least one portion of the text segment to obtain a first answer to a first question of the set of predetermined questions; and
applying the QA machine learning model to the at least one portion of the text segment to obtain a second answer to a second question of the set of predetermined questions, wherein a component of the second question is based on the first answer.

20. The computer program product of claim 16, wherein the QA machine learning model has been trained using a training dataset comprising pairs of inputs and corresponding outputs, wherein each of the output is a portion of a label of an element of a business process model, and each of the input is extracted from a text segment that describes the element by at least one of:
removing one or more sentences in the text segment that are at one or more lower levels of a hierarchy structure of the text segment; and
removing one or more sentences in the text segment that contain predefined keywords.
